(19) United States
(12) Patent Application Publication
(10) Pub. No.: US 2017/0019041 A1
(43) Pub. Date: Jan. 19, 2017

(54) CONTROL DEVICE FOR PERMANENT-MAGNET ROTARY MOTOR

(71) Applicant: MITSUBISHI ELECTRIC CORPORATION, Tokyo (JP)

(72) Inventors: Makoto SUGIYAMA, Tokyo (JP); Koki NAKA, Tokyo (JP); Hisashi OTSUKA, Tokyo (JP); Shinichi YAMAGUCHI, Tokyo (JP); Eigo TOTOKI, Tokyo (JP)

(73) Assignee: Mitsubishi Electric Corporation, Tokyo (JP)

(21) Appl. No.: 15/121,181

(22) PCT Filed: Feb. 28, 2014
(86) PCT No.: PCT/JP2014/055145

§ 371 Date: Aug. 24, 2016

(51) Int. Cl. H02P 6/10; H02P 27/08; H02P 21/22; H02K 1/27

(52) U.S. Cl. CPC H02P 6/10; H02K 1/2706; H02P 27/08; H02P 21/22; H02P 2205/05

(57) ABSTRACT

A control device converts phase currents supplied to a permanent-magnet rotary motor into a d-axis current and a q-axis current on a dq coordinate axis, and calculates a current command (a d-axis current command or a q-axis current command) for changing at least one of values of the d-axis current and the q-axis current according to a rotor position, based on a torque command, the d-axis current and the q-axis current, so as to cause a magnitude of a reverse magnetic field acting on a permanent-magnet end part to be equal to or lower than a magnetic coercive force of a permanent magnet.

### FIELD

The present invention relates to a control device for a permanent-magnet rotary motor.

### BACKGROUND

In recent years, there has been an increased number of examples of a method for executing drive control on a permanent-magnet rotary motor using an inverter in an application field of an AC motor for an industrial apparatus and the like. As a method for executing drive control on a permanent-magnet rotary motor, for example, a U-phase current, a V-phase current and a W-phase current (phase currents Iu, Iv, Iw) that are input currents to the permanent-magnet rotary motor are converted into a d-axis current in the same phase as that of a magnetic flux axis of a field and a q-axis current orthogonal to the magnetic flux axis of the field, with reference to phase angle.

As a method for suppressing demagnetization of a permanent magnet, for example, Patent Literature 1 listed below discloses a method of changing a magnitude of a q-axis current command based on a position of a rotor to suppress a demagnetization effect in a demagnetization determination process.

### CITATION LIST

### Patent Literature

Patent Literature 1: Japanese Patent Application Laid-open No. 2005-151714

### SUMMARY

### Technical Problem

However, a conventional technique represented by Patent Literature 1 listed above has suffered a following problem. When a permanent-magnet rotary motor is to be operated with a constant speed and a constant torque, a q-axis current command value is made to be constant, and thereby phase currents Iu, Iv and Iw for respective phases are converted in from a dq-axis coordinate system into a three-phase AC coordinate system according to a dq-axis current command, and become sinusoidal. It is desirable that the phase currents Iu, Iv and Iw of the respective phases are sinusoidal in terms of suppressing torque pulsation. However, in a permanent-magnet rotary motor, there are rotor positions where a reverse magnetic field is likely to act largely on a circumferential end part (a permanent magnet end part) of a permanent magnet, which cause a problem that demagnetization occurs.

The present invention has been achieved in view of the above circumstances, and its object is to provide a control device of a permanent-magnet rotary motor capable of improving demagnetization resistance of a permanent magnet while suppressing torque pulsation.

### Solution to Problem

In order to solve the above-mentioned problem and achieve the object, the present invention provides a control device for a permanent-magnet rotary motor, wherein the control device converts phase currents supplied to the permanent-magnet rotary motor into a d-axis current and a q-axis current on a dq coordinate axis, and calculates a current command for changing at least one of values of the d-axis current and the q-axis current according to a rotor position of a rotor of the permanent-magnet rotary motor, based on a torque command, the d-axis current and the q-axis current in a manner that a magnitude of a reverse magnetic field acting on a circumferential end part of a permanent magnet provided for the rotor is caused to be equal to or lower than a magnetic coercive force of the permanent magnet.

### Advantageous Effects of Invention

According to the present invention, it is possible to improve demagnetization resistance of a permanent magnet while suppressing torque pulsation.

### BRIEF DESCRIPTION OF DRAWINGS

FIG. 1 is a block diagram illustrating a configuration example of a control device of a permanent-magnet rotary motor according to first to third embodiments of the present invention.

FIG. 2 is a sectional view of a permanent-magnet rotary motor according to the first to third embodiments of the present invention.

FIG. 3 is a sectional enlarged view of a permanent magnet illustrated in FIG. 2.

FIG. 4 is a chart illustrating waveforms of currents controlled by the control device of a permanent-magnet rotary motor according to the first embodiment of the present invention.

FIG. 5 is a chart illustrating a reverse magnetic field acting on permanent-magnet end parts of the permanent-magnet rotary motor according to the first embodiment of the present invention.

FIG. 6 is a chart illustrating waveforms of currents controlled by conventional techniques.

FIG. 7 is a chart illustrating a reverse magnetic field acting on permanent-magnet end parts driven by the currents illustrated in FIG. 6.

FIG. 8 is a chart illustrating waveforms of currents controlled by the control device of a permanent-magnet rotary motor according to the second embodiment of the present invention.

FIG. 9 is a chart illustrating a reverse magnetic field acting on permanent-magnet end parts of the permanent-magnet rotary motor according to the second embodiment of the present invention.

FIG. 10 is a chart illustrating waveforms of currents controlled by the control device of a permanent-magnet rotary motor according to the third embodiment of the present invention.

FIG. 11 is a diagram illustrating a reverse magnetic field acting on permanent-magnet end parts of the permanent-magnet rotary motor according to the third embodiment of the present invention.

### DESCRIPTION OF EMBODIMENTS

Embodiments of a control device of a permanent-magnet rotary motor according to the present invention will be described below in detail with reference to the drawings. The present invention is not limited to the embodiments.

### First Embodiment

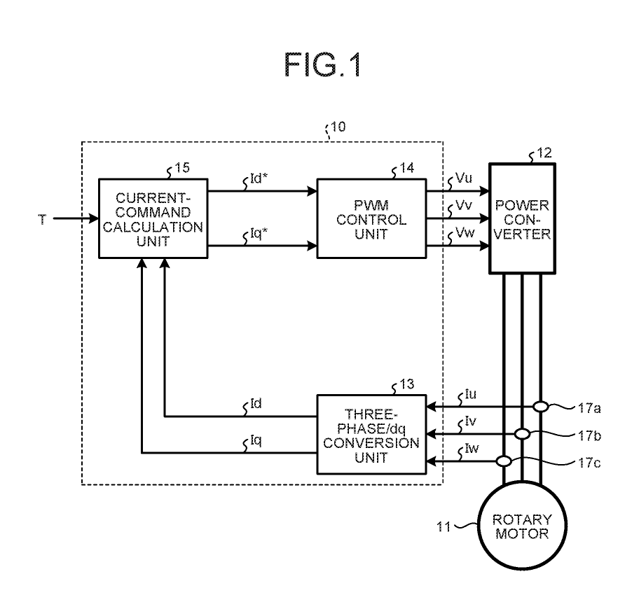

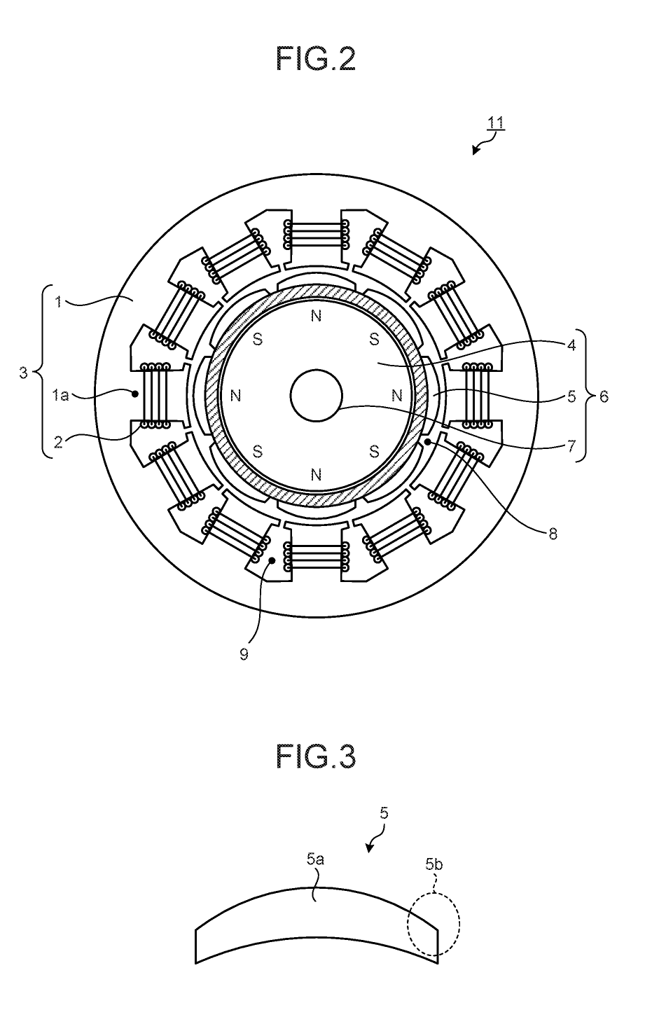

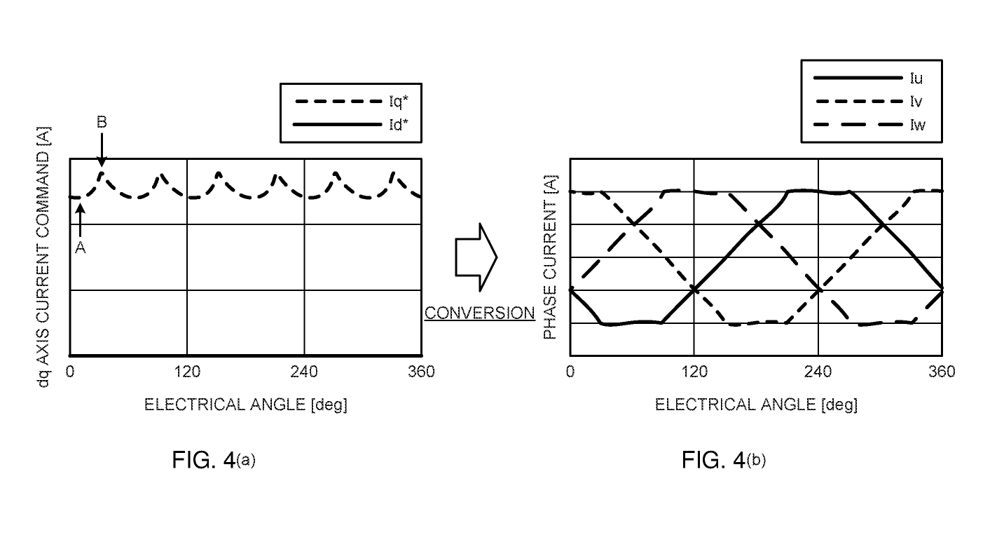

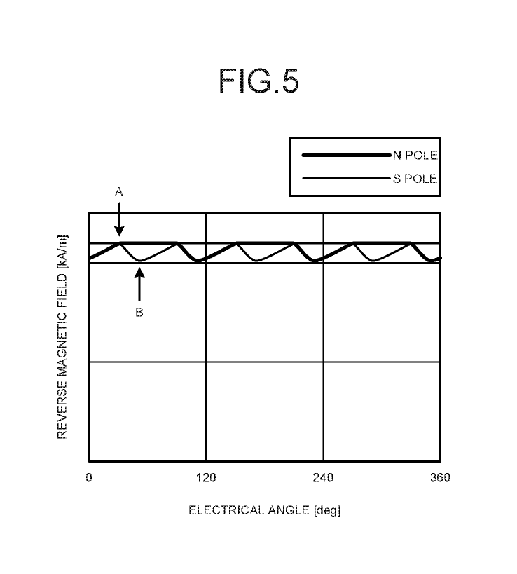

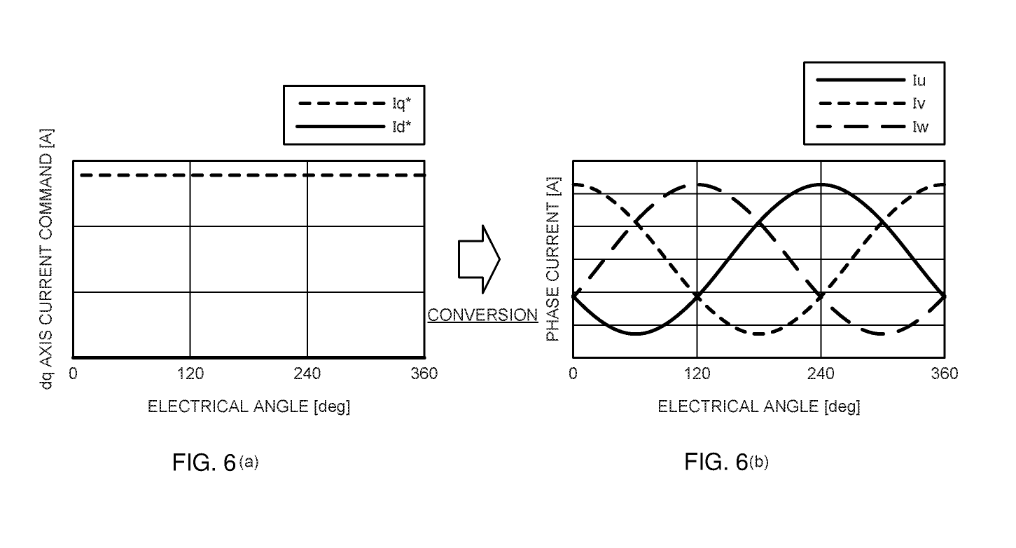

FIG. 1 is a block diagram illustrating a configuration example of a control device 10 of a permanent-magnet rotary motor 11 according to first to third embodiments of the present invention. FIG. 2 is a sectional view of the permanent-magnet rotary motor 11 according to the first to third embodiments of the present invention. FIG. 3 is a sectional enlarged view of a permanent magnet 5 illustrated in FIG. 2. FIG. 4 is a chart illustrating waveforms of currents controlled by the control device 10 of the permanent-magnet rotary motor 11 according to the first embodiment of the present invention. FIG. 5 is a chart illustrating a reverse magnetic field acting on permanent-magnet end parts 5b of the permanent-magnet rotary motor 11 according to the first embodiment of the present invention. In the following description, the permanent-magnet rotary motor 11 according to the embodiment is referred to simply as “motor 11” unless otherwise stated.

The control device 10 illustrated in FIG. 1 is configured to have a three-phase/dq conversion unit 13, a PWM control unit 14 and a current-command calculation unit 15, for a main construction, and controls a power converter 12 so as to make a torque of the motor 11 matched with a torque command T.

The motor 11 that is an AC rotary machine is connected to the power converter 12. The power converter 12 is controlled by the control device 10 to convert DC power into AC power of an arbitrary frequency, and supplies the after-conversion AC power to the motor 11. Current detection units 17a, 17b and 17c such as CTs (current transformers) are placed in three connecting lines that connect the power converter 12 and the motor 11, respectively. In the current detection units 17a, 17b and 17c, phase currents Iu, Iv and Iw for respective phases generated in the motor 11 are detected, and the detected phase currents Iu, Iv and Iw for the respective phases are provided to the three-phase/dq conversion unit 13.

The three-phase/dq conversion unit 13 converts the phase currents Iu, Iv and Iw for the respective phases acquired from the current detection units 17a, 17b and 17c into a d-axis current Id and a q-axis current Iq on a dq coordinate axis and outputs the currents Id and Iq to the current-command calculation unit 15.

The current-command calculation unit 15 is provided with an input of, for example, a torque command T having been outputted from an external control device (not illustrated), and the current-command calculation unit 15 detects a rotor angle (rotor position) of the motor 11 using the d-axis current Id and the q-axis current Iq. The current-command calculation unit 15 also calculates a q-axis current command Iq* and a d-axis current command Id* based on the rotor position, the torque command T, the d-axis current Id and the q-axis current Iq.

The PWM control unit 14 calculates three-phase voltage commands Vu, Vv and Vw that are gate drive signals based on the q-axis current command Iq* and the d-axis current command Id* and outputs the voltage commands to the power converter 12.

The motor 11 illustrated in FIG. 2 includes a stator core 1 and a rotor 6. A stator 3 includes the stator core 1 formed in an annular shape, and stator windings 2 to which external power is supplied. A plurality of groups of teeth 1a evenly spaced in a circumferential direction are formed on an inner circumferential side of the stator core 1, and slots 9 are formed between the adjacent groups of teeth 1a. The rotor 6 is placed with a clearance 8 interposed on an inner diameter side of the stator core 1, and a rotor shaft 7 is provided at the center of the rotor 6. Permanent magnets 5 having different polarities are arranged alternately in a circumferential direction on an outer-diameter side surface of a rotor core 4. Although the motor 11 exemplified in the drawings has eight poles and 12 slots as an example, other combinations of the number of magnetic poles and the number of the slots 9 may be used.

FIG. 3 enlargedly illustrates the permanent magnet 5 illustrated in FIG. 2. As in the illustrated example, the permanent magnet 5 is formed to have a trapezoidal shape in cross-section or a D-shape in cross-section. Due to this shape factor, the permanent magnet 5 is easier to be demagnetized by a reverse magnetic field in a position more close to a circumferential end part (the permanent-magnet end part 5b) than at a circumferential center part 5a.

The current-command calculation unit 15 of the control device 10 according to the present embodiment is configured to change a value of the q-axis current command Iq* according to the rotor position so as to cause a magnitude of the reverse magnetic field acting on the permanent-magnet end parts 5b to be equal to or lower than a magnetic coercive force of the permanent magnet 5 when the motor 11 is to be operated at a constant speed and with a constant torque.

An operation of the control device 10 according to the present embodiment is described with reference to FIGS. 4 and 5. In FIG. 4(a), there is shown a relation between an electrical angle representing a rotation position of the rotor 6 and a dq-axis current command value (values of the d-axis current command Id* and the q-axis current command Iq*). As in the illustrated example, while the value of the q-axis current command Iq* changes according to the rotor position, the value of the d-axis current command Id* is zero. In FIG. 4(b), there is shown the phase currents Iu, Iv and Iw for the respective phases obtained by the conversion from the dq-axis coordinate system according to the dq-axis current command value in FIG. 4(a).

As illustrated in FIG. 4(a), the value of the q-axis current command Iq* is suppressed at rotor positions where a large reverse magnetic field acts on the permanent-magnet end parts 5b (peaks denoted by a sign A in FIG. 5), and the value of the q-axis current command Iq* becomes high, for example, becomes maximum at rotor positions where a large reverse magnetic field does not act on the permanent-magnet end parts 5b (valleys denoted by a sign B in FIG. 5).

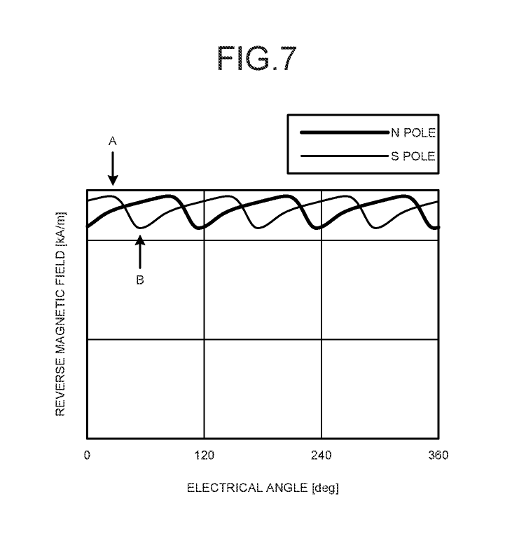

FIG. 6 is a chart illustrating waveforms of currents controlled by conventional techniques. FIG. 7 is a chart illustrating a reverse magnetic field acting on the permanent-magnet end parts 5b driven by the currents illustrated in FIG. 6. In a conventional technique represented by Patent Literature 1 listed above, when the motor 11 is to be operated at a constant speed and with a constant torque, the value of the q-axis current command Iq* is controlled to be constant regardless of the rotor positions as illustrated in FIG. 6(a). FIG. 6(b) illustrates the phase currents Iu, Iv and Iw of the respective phases obtained by the conversion from the dq-axis coordinate system to the three-phase AC coordinate system according to the dq-axis current command value in FIG. 6(a).

By keeping the value of the q-axis current command Iq* constant in this way, the phase currents Iu, Iv and Iw for the respective phases become sinusoidal. It is desirable that the phase currents Iu, Iv and Iw for the respective phases are sinusoidal in terms of suppressing the torque pulsation. However, when this control is executed, a reverse magnetic field largely acts on the permanent-magnet end parts 5b, resulting in demagnetization.

To solve this problem, the control device 10 according to the present embodiment is configured to change the q-axis current command Iq* according to the rotor position so as to cause the magnitude of the reverse magnetic field acting on the permanent-magnet end parts 5b to be equal to or lower than the magnetic coercive force of the permanent magnets 5. This prevents demagnetization of the permanent-magnet end parts 5b. Furthermore, because the value of the q-axis current command Iq* is suppressed only at specific rotor positions, reduction in the torque can be minimized.

The current-command calculation unit 15 illustrated in FIG. 1 is configured to detect the rotor angle (rotor position) of the motor 11 using the d-axis current Id and the q-axis current Iq. However, the method of detecting the rotor position is not limited to this example. For example, position detection means such as a rotation angle sensor may be provided to the motor 11 to detect the rotor position based on a position signal outputted from the position detection means. Although the current detection units 17a, 17b and 17c are used as means for detecting the phase currents Iu, Iv and Iw for the respective phases in the present embodiment, other publicly known methods may be used to detect the phase currents Iu, Iv and Iw for the respective phases. For example, when CTs are disposed only on two connecting lines of the U phase and the V phase, the phase current Iw for the W phase can be obtained from detected currents for the U phase and the V phase because a relation Iu+Iv+Iw=0 holds. Therefore, any one of the three current detection units 17a, 17b and 17c may be omitted.

As described above, the control device 10 according to the present embodiment is configured to calculate the q-axis current command Iq* for the q-axis current Iq so as to cause the q-axis current Iq with a value smaller than a value of the q-axis current Iq flowing at rotor positions (the positions denoted by the sign B) where a reverse magnetic field smaller than the magnetic coercive force of the permanent magnet 5 acts on the permanent-magnet end parts 5b to flow at rotor positions (the positions denoted by the sign A) where a reverse magnet field larger than the magnetic coercive force of the permanent magnet 5 acts on the permanent-magnet end parts 5b. This configuration suppresses the q-axis current Iq at specific rotor positions, so that demagnetization of the permanent-magnet end parts 5b can be avoided while the torque pulsation is suppressed and also reduction in the torque can be minimized.

### Second Embodiment

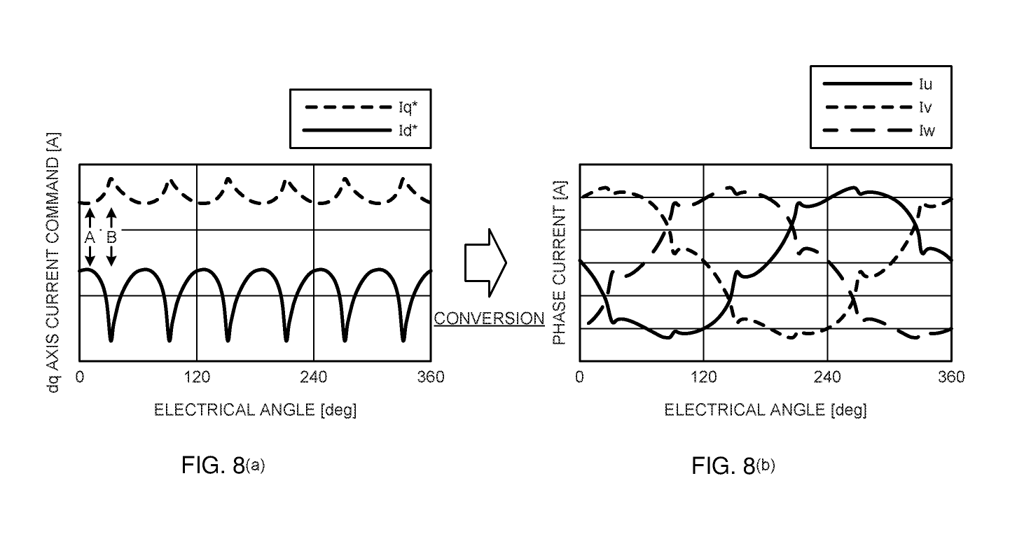

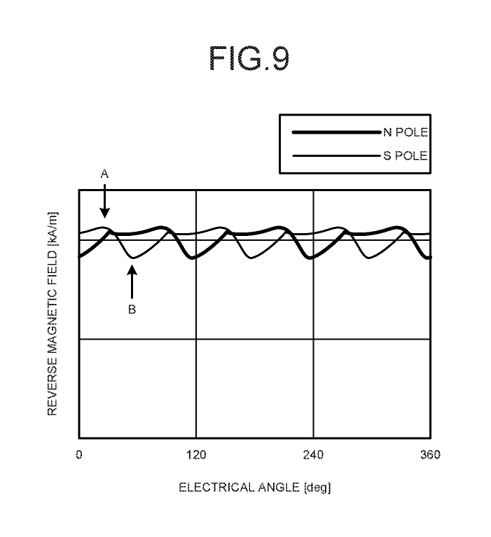

FIG. 8 is a chart illustrating waveforms of currents controlled by the control device 10 of the permanent-magnet rotary motor 11 according to the second embodiment of the present invention. FIG. 9 is a chart illustrating a reverse magnetic field acting on the permanent-magnet end parts 5b of the permanent-magnet rotary motor 11 according to the second embodiment of the present invention.

The control device 10 according to the present embodiment is configured to calculate the d-axis current command Id* for the d-axis current Id so as to cause the d-axis current Id with a value larger than a value of the d-axis current Id flowing at rotor positions (positions denoted by a sign B) where a reverse magnetic field smaller than the aforementioned magnetic coercive force acts on the permanent-magnet end parts 5b to flow at rotor positions (positions denoted by a sign A) where a reverse magnetic field larger than the aforementioned magnetic coercive force acts on the permanent-magnet end parts 5b, when the motor 11 is to be operated at a constant speed and with a constant torque. In the following description, parts identical to those of the first embodiment are denoted by the same reference signs and descriptions thereof will be omitted, and only parts different from those of the first embodiment are described.

An operation of the control device 10 according to the present embodiment is described with reference to FIGS. 8 and 9. FIG. 8(a) illustrates a relation between an electrical angle representing a rotation position of the rotor 6 and a dq-axis current command value. The value of the q-axis current command Iq* is suppressed at rotor positions (peaks indicated by the sign A in FIG. 9) where a large reverse magnetic field acts on the permanent-magnet end parts 5b, and becomes high, for example, maximum at rotor positions (valleys indicated by the sign B in FIG. 9) where a large reverse magnetic field does not act on the permanent-magnet end parts 5b, similarly to the first embodiment. On the other hand, the value of the d-axis current command Id* becomes high at the rotor positions where a large reverse magnetic field acts on the permanent-magnet end parts 5b and is suppressed at the rotor positions where a large reverse magnetic field does not act on the permanent-magnet end parts 5b. By causing a relatively-strong field d-axis current to flow in this way, demagnetization resistance can be increased.

In FIG. 8(b), there is shown the phase currents Iu, Iv and Iw of the respective phases obtained by the conversion from the dq-axis coordinate system to the three-phase AC coordinate system according to the dq-axis current command value in FIG. 8(a).

In this way, the control device 10 according to the second embodiment is configured to decrease the value of the q-axis current command Iq* and increase the value of the d-axis current command Id* at rotor positions where a large reverse magnetic field acts on the permanent-magnet end parts 5b, and increase the value of the q-axis current command Iq* and decrease the value of the d-axis current command Id* at rotor positions where a large reverse magnetic field does not act on the permanent-magnet end parts 5b. This configuration can further increase the demagnetization resistance while suppressing the maximum current outputted from the power converter 12 to the same level as that in the first embodiment.

### Third Embodiment

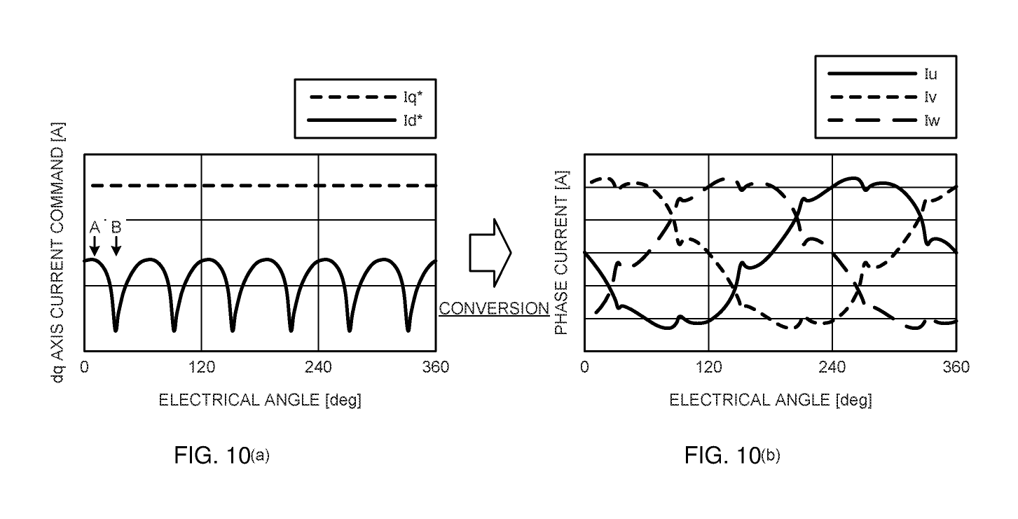

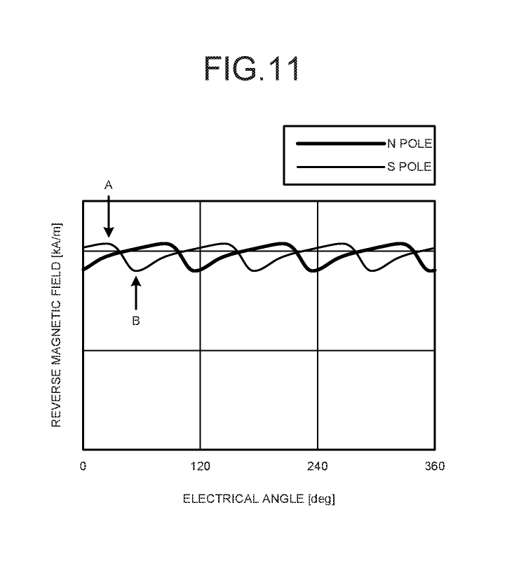

FIG. 10 is a chart illustrating waveforms of currents controlled by the control device 10 of the permanent-magnet rotary motor 11 according to the third embodiment of the present invention. FIG. 11 is a chart illustrating a reverse magnetic field acting on the permanent-magnet end parts 5b of the permanent-magnet rotary motor 11 according to the third embodiment of the present invention.

The control device 10 according to the third embodiment is configured to calculate the q-axis current command Iq* for the q-axis current Iq so as to keep the value of the q-axis current Iq constant regardless of the rotor positions and also calculate the d-axis current command Id* for the d-axis current Id so as to cause the d-axis current Id with a value larger than a value of the d-axis current Id flowing at rotor positions (positions denoted by a sign B) where a reverse magnetic field smaller than the aforementioned magnetic coercive force acts on the permanent-magnet end parts 5b to flow at rotor positions (positions denoted by a sign A) where a reverse magnetic field larger than the aforementioned magnetic coercive force acts on the permanent-magnet end parts 5b. In the following description, parts identical to those of the first embodiment are denoted by the same reference signs and descriptions thereof will be omitted, and only parts different from those of the first embodiment are described.

An operation of the control device 10 according to the present embodiment is described with reference to FIGS. 10 and 11. FIG. 10(a) illustrates a relation between an electrical angle representing a rotation position of the rotor 6 and a dq-axis current command value. The value of the q-axis current command Iq* is at a constant level regardless of the rotor positions. On the other hand, the value of the d-axis current command Id* becomes high at rotor positions where a large reverse magnetic field acts on the permanent-magnet end parts 5b and is suppressed at rotor positions where a large reverse magnetic field does not act on the permanent-magnet end parts 5b.

FIG. 10(b) illustrates the phase currents Iu, Iv and Iw for the respective phases obtained by the conversion from the dq-axis coordinate system to the three-phase AC coordinate system according to the dq-axis current command value in FIG. 10(a).

In this manner, the control device 10 according to the third embodiment is configured to fix the value of the q-axis current command Iq* at a constant level regardless of the rotor positions of the rotor 6, and to increase the value of the d-axis current command Id* at rotor positions where a large reverse magnetic field acts on the permanent-magnet end parts 5b and decrease the value of the d-axis current command Id* at rotor positions where a large reverse magnetic field does not act on the permanent-magnet end parts 5b. By virtue of this configuration, a relatively-strong field d-axis current Id flows at rotor positions where a large reverse magnetic field acts on the permanent-magnet end parts 5b, so that the demagnetization resistance can be enhanced. Furthermore, because the q-axis current command Iq* is constant regardless of the rotor positions, the torque pulsation is reduced and the d-axis current Id is caused to flow only at specific rotor positions, so that copper loss can be reduced.

As described above, the control device 10 according to the first to third embodiments is configured to convert the phase currents supplied to the motor 11 into the d-axis current Id and the q-axis current Iq on the dq coordinate axis, and calculate a current command (the d-axis current command Id* and the q-axis current command Iq*) for changing at least one of values of the d-axis current Id and the q-axis current Iq according to the rotor position, based on the torque command T, the d-axis current

Id and the q-axis current Iq so as to cause the magnitude of a reverse magnetic field acting on the permanent-magnet end parts 5b to be equal to or lower than the magnetic coercive force of the permanent magnet 5. This configuration suppresses the q-axis current Iq at a specific rotor position and thus the demagnetization resistance of the permanent magnets 5 can be increased while the torque pulsation is suppressed.

The control device 10 according to the first to third embodiments may be configured so as to superimpose a component having a frequency six times a power-supply frequency on the q-axis current Iq at rotor positions where a large reverse magnetic field does not act on the permanent-magnet end parts 5b.

Alternatively, the control device 10 according to the first to third embodiments may be configured so as to superimpose a component having a frequency six times a power-supply frequency on the d-axis current Id at rotor positions where a large reverse magnetic field acts on the permanent-magnet end parts 5b. This configuration can efficiently prevent the demagnetization.

The first to third embodiments are only examples of the subject matters of the present invention, and can be combined with further different publicly known techniques, and it is needless to mention that the configuration can be realized with some modification such as omission of part thereof without departing from the scope of the present invention.

### INDUSTRIAL APPLICABILITY

As described above, the present invention can be applied to a control device for a permanent-magnet rotary motor, and is particularly useful as an invention that can increase demagnetization resistance of a permanent magnet while suppressing torque pulsation.

### REFERENCE SIGNS LIST

1 stator core, 1a teeth, 2 stator winding, 3 stator, 4 rotor core, 5 permanent magnet, 5a circumferential center part, 5b permanent-magnet end part, 6 rotor, 7 rotor shaft, 8 clearance, 9 slot, 10 control device, 11 permanent-magnet rotary motor, 12 power converter, 13 three-phase/dq conversion unit, 14 PWM control unit, 15 current-command calculation unit, 17a, 17b, 17c current detection unit.

1. A control device for a permanent-magnet rotary motor, wherein the control device converts phase currents supplied to the permanent-magnet rotary motor into a d-axis current and a q-axis current on a dq coordinate axis, and calculates a current command for a q-axis current according to a rotor position of a rotor of the permanent-magnet rotary motor, based on a torque command, the d-axis current and the q-axis current in a manner that a magnitude of a reverse magnetic field acting on a circumferential end part of a permanent magnet provided for the rotor is caused to be equal to or lower than a magnetic coercive force of the permanent magnet, and in a manner that a q-axis current with a value smaller than a value of a q-axis current flowing at the rotor position where a reverse magnetic field smaller than the magnetic coercive force acts on the circumferential end part of the permanent magnet is caused to flow at the rotor position where a reverse magnetic field larger than the magnetic coercive force acts on the circumferential end part.

2. A control device for a permanent-magnet rotary motor, wherein the control device converts phase currents supplied to the permanent-magnet rotary motor into a d-axis current and a q-axis current on a dq coordinate axis, and calculates a current command for a q-axis current according to a rotor position of a rotor of the permanent-magnet rotary motor, based on a torque command, the d-axis current and the q-axis current in a manner that a magnitude of a reverse magnetic field acting on a circumferential end part of a permanent magnet provided for the rotor is caused to be equal to or lower than a magnetic coercive force of the permanent magnet, and in a manner that a q-axis current with a value smaller than a value of a q-axis current flowing at the rotor position where a reverse magnetic field smaller than the magnetic coercive force acts on the circumferential end part of the permanent magnet is caused to flow at the rotor position where a reverse magnetic field larger than the magnetic coercive force acts on the circumferential end part, and calculates a current command for a d-axis current in a manner that a d-axis current with a value larger than a value of a d-axis current flowing at the rotor position where a reverse magnetic field smaller than the magnetic coercive force acts on the circumferential end part of the permanent magnet is caused to flow at the rotor position where a reverse magnetic field larger than the magnetic coercive force acts on the circumferential end part.

3. (canceled)

4. A control device for a permanent-magnet rotary motor, wherein the control device
converts phase currents supplied to the permanent-magnet rotary motor into a d-axis current and a q-axis current on a dq coordinate axis, and calculates a current command for a q-axis current in a manner of keeping a value of a q-axis current constant regardless of the rotor position according to a rotor position of a rotor of the permanent-magnet rotary motor, based on a torque command, the d-axis current and the q-axis current in a manner that a magnitude of a reverse magnetic field acting on a circumferential end part of a permanent magnet provided for the rotor is caused to be equal to or lower than a magnetic coercive force of the permanent magnet, and
calculates a current command for a d-axis current in a manner that a d-axis current with a value larger than that of a d-axis current flowing at the rotor position where a reverse magnetic field smaller than the magnetic coercive force acts on the circumferential end part of the permanent magnet is caused to flow at the rotor position where a reverse magnetic field larger than the magnetic coercive force acts on the circumferential end part.

5. The control device for a permanent-magnet rotary motor according to claim 1, wherein the control device superimposes a component having a frequency six times a power-supply frequency on the q-axis current at the rotor position where a reverse magnetic field smaller than the magnetic coercive force acts on the circumferential end part of the permanent magnet.

6. The control device for a permanent-magnet rotary motor according to claim 1, wherein the control device superimposes a component having a frequency six times a power-supply frequency on the d-axis current at the rotor position where a reverse magnetic field larger than the magnetic coercive force acts on the circumferential end part of the permanent magnet.

7. The control device for a permanent-magnet rotary motor according to claim 2, wherein the control device superimposes a component having a frequency six times a power-supply frequency on the q-axis current at the rotor position where a reverse magnetic field smaller than the magnetic coercive force acts on the circumferential end part of the permanent magnet.

8. The control device for a permanent-magnet rotary motor according to claim 2, wherein the control device superimposes a component having a frequency six times a power-supply frequency on the d-axis current at the rotor position where a reverse magnetic field larger than the magnetic coercive force acts on the circumferential end part of the permanent magnet.

9. The control device for a permanent-magnet rotary motor according to claim 4, wherein the control device superimposes a component having a frequency six times a power-supply frequency on the q-axis current at the rotor position where a reverse magnetic field smaller than the magnetic coercive force acts on the circumferential end part of the permanent magnet.

10. The control device for a permanent-magnet rotary motor according to claim 4, wherein the control device superimposes a component having a frequency six times a power-supply frequency on the d-axis current at the rotor position where a reverse magnetic field larger than the magnetic coercive force acts on the circumferential end part of the permanent magnet.
